(19) United States
(12) Patent Application Publication
(10) Pub. No.: US 2014/0260452 A1
(43) Pub. Date: Sep. 18, 2014

(54) Electronic Lock

(71) Applicant: Hsu-Chih CHEN, Longtan Township (TW)

(72) Inventor: Hsu-Chih CHEN, Longtan Township (TW)

(21) Appl. No.: 13/802,831

(22) Filed: Mar. 14, 2013

(51) Int. Cl. G07C 9/00

(52) U.S. Cl. CPC G07C 9/00174
USPC 70/279.1; 70/277

(57) ABSTRACT

An electronic lock is disclosed, which generally comprises a main lock body, a control mechanism being cooperatively connected with the main lock body, and at least one portable communication device. The control mechanism includes a connection interface connecting to the main lock body, a central processing unit connecting to the connection interface, a communication unit connecting to the central processing unit, and a power supply unit connecting to the central processing unit. The portable communication device, being capable of conducting a handshake communication with the communication unit of the control mechanism, so that the control mechanism can be controlled by the portable communication device to conduct a locking or unlocking operation for the main lock body. The portable communication device can be used as a key and can be appropriately copied through the control mechanism. Furthermore, the present invention allows authorization division for the key to increase the security.

### TECHNICAL FIELD OF THE INVENTION

The present invention relates to an electronic lock and, more particularly, to an electronic lock that allows a portable communication device to be used as a key to wireless control a control mechanism of the electronic lock so as to conduct a locking or unlocking operation for a main lock body of the electronic lock, and that allows multiple copies and authorization division for the key, so as to increase the security of the electronic lock.

### DESCRIPTION OF THE PRIOR ART

Generally, conventional locks can be classified into three types: mechanical locks by using physical keys, electronic locks by using physical keys with wireless magnetic cards, and electronic locks by inputting passwords through keyboards.

Regarding the conventional mechanical locks, a professional tool is required to copy a physical key. For this type of lock, there is no way to restrict a further copy of the physical key. Also, this type of lock is unable to provide information about the final state of the lock, being locked or unlocked.

Regarding the conventional electronic keys by using physical keys with wireless magnetic cards, it is difficult for a physical key of this type of lock to be copied. Even though the physical key can be successfully copied, the copy operation is unable to control the available access count or time for a copied physical key.

Regarding the conventional electronic keys by inputting passwords through keyboards, the password might be revealed to the third parties or obtained by thieves through peeping or recording.

As an example, for application in a safety deposit box, although a conventional lock, being of mechanical or electronic type, can be designed in a form that it can be opened only if more than one physical key are available, it is difficult for a physical key of the conventional lock to be set with an authorization level. Also, it is difficult for an authorization level to be divided and set on multiple physical keys. Besides, the physical keys might be stolen and copied by thieves. Thus, the conventional locks cannot be applied in the case that requires high security

### SUMMARY OF THE INVENTION

The primary object of the present invention is to provide an electronic lock that allows a portable communication device to be used as a key to wireless control a control mechanism of the electronic lock so as to conduct a locking or unlocking operation for a main lock body of the electronic lock, and that allows multiple copies and authorization division for the key, so as to increase the security of the electronic lock.

To achieve the above object, the present invention provides an electronic lock, which generally comprises a main lock body, a control mechanism being cooperatively connected with the main lock body, and at least one portable communication device. The control mechanism includes a connection interface connecting to the main lock body, a central processing unit connecting to the connection interface, a communication unit connecting to the central processing unit, and a power supply unit connecting to the central processing unit. The portable communication device, being capable of conducting a handshake communication with the communication unit of the control mechanism, so that the control mechanism can be controlled by the portable communication device to conduct a locking or unlocking operation for the main lock body.

Other objects, advantages, and novel features of the present invention will become more apparent from the following detailed description when taken in conjunction with the accompanying drawings.

### BRIEF DESCRIPTION OF THE DRAWINGS

FIG. 1 shows a schematic 3-dimensional view of the present invention.

FIG. 2 shows a schematic functional diagram of the present invention.

FIG. 3 shows a visual interface for showing a password generated from the unlocking module.

FIG. 4 shows a visual interface for facilitating a user to operate the electronic lock of the present invention.

### DETAILED DESCRIPTION OF THE PREFERRED EMBODIMENTS

Referring to FIGS. 1 through 4, an electronic lock according to one embodiment of the present invention is disclosed, which generally comprises a main lock body 1, a control mechanism 2, and at least one portable communication device 3.

The main lock body 1 includes a latch bolt 11 and a linking mechanism 12 linked to the latch bolt 11, wherein the linking mechanism 12 can be inserted with a physical key 13.

The control mechanism 2, which is cooperatively connected with the main lock body 1, includes a connection interface 21 connecting to the linking mechanism 12 provided in the main lock body 1, a central processing unit 22 connecting to the connection interface 21, a communication unit 23 connecting to the central processing unit 22, and a power supply unit 24 connecting to the central processing unit 22. The central processing unit 22 includes a storage module 221, an authentication module 222, an unlocking module 223, a signal transmission module 224, a copy module 225, and an authorization weight module 226. The communication unit 23 is based on a bluetooth protocol, a short-range wireless protocol, or a wireless local area network (WLAN or Wi-Fi). Furthermore, the control mechanism 2 may further include an emergency unit 25 connecting to the central processing unit 22 and a signal intensity processing unit 26 connecting to the central processing unit 22.

The portable communication device 3 can conduct a handshake communication with the communication unit 23 of the control mechanism 2, so that the control mechanism 2 can be controlled by the portable communication device 3 to conduct a locking or unlocking operation for the main lock body 1. The portable communication device 3 can be a mobile telephone, a personal digital assistant (PDA), or a computer. The unlocking modules 223 can cooperate with the portable communication device 3 to allow the portable communication device 3 to create a visual interface 2231 for showing a password and a visual interface 2232 for facilitating a user to operate the electronic lock.

In use, first of all, the physical key 13 is inserted into the linking mechanism 12 of the main lock body 1 to conduct a turning operation, so that the linking mechanism 12 of the main lock body 1 can interact with the control mechanism 2 via the connection interface 21, so that the electronic lock of the present invention can enter into a configuration state, which allows a user to employ the portable communication device 3, now being known as the primary portable communication device, to conduct a handshake communication with the communication unit 23 of the control mechanism 2. The primary portable communication device 3 allows the user to enter authentication code to continue the configuration with the central processing unit 22 of the control mechanism 2. After the authentication module 222 of the central processing unit 22 confirms the authentication code inputted by the user, the unlocking module 223 can send a password certification to the primary portable communication device 3 via the communication unit 23 and thus the primary portable communication device 3 can create a visual interface 2231 for showing the password, as shown in FIG. 3. Thereafter, when the user inputs a password, the authentication module 222 can conduct an authentication procedure for the inputted password, and then can store information about the primary portable communication device 3 in the storage module 221 if the inputted password is the same as the password generated from the unlocking module 223 for the primary portable communication device 3. Thereafter, the primary portable communication device 3 can serve as a primary key 13 for operating the electronic lock. With the primary portable communication device 3, the communication unit 23, the signal transmission module 224 of the central processing unit 22, the linking mechanism 12, and the latch bolt 11, the user can conduct a locking or unlocking operation for the main lock body 1 through a visual interface 2232 created on the portable communication device 3, as shown in FIG. 4. Furthermore, after the main lock body 1 has been locked or unlocked, the user may know the final state of the main lock body 1 by using the portable communication device 3 being wireless communicated with the communication unit 23 of the control mechanism 2 of the electronic lock, because the final state of the main lock body 1, being “locked” or “unlocked”, has been stored in the storage module 221 of the central processing unit 22 of the electronic lock. This feature may facilitate the user to operate the electronic lock.

Furthermore, when additional (secondary) portable communication devices are required to be served as keys for the electronic lock, the user may employ the primary portable communication device 3 to communicate with the central processing unit 22 of the control mechanism 2 via the communication unit 23 and issue commands to allow the copy module 225, in cooperation with the unlocking module 223, to dynamically generate passwords for the additional portable communication devices and can send password certifications to the additional portable communication devices, so that the additional portable communication devices can serve as the secondary keys for operating the electronic device. The storage module 221 of the central processing unit 22 can store both of the primary key for the primary portable communication device and the secondary keys for the additional portable communication devices. The secondary keys contain encrypted authorization information and are different from each other, so that once a secondary communication device communicates with the control mechanism 2 of the electronic lock, the control mechanism 2 can know the authorization of the secondary potable communication device. The users of the secondary portable communication devices are not allowed to modify the authorizations of the secondary portable communication devices, and they should conduct operations according to the authorizations rendered by the primary portable communication device. When the secondary keys are copied for the secondary portable communication devices by the primary portable communication device, the secondary portable communication devices are not required to make connections with the control mechanism 2. Among all the portable communication devices 3, the primary portable communication device 3 would be given the highest administrative privilege by the central processing unit 22 of the control mechanism 2, whereby the primary portable communication device 3 may communicate with the control mechanism 2 to revoke the privileges given to the secondary portable communication devices, or the primary portable communication device 3 may request the control mechanism 2 to issue new secondary keys for the secondary portable communication devices. As an example, the allowable count or time for allowing a secondary portable communication device to be used as a key for entering or leaving a place can be adjusted at the disposal of the user who has the primary portable communication device. Also, the original privilege of any secondary portable communication device can be cancelled through the primary portable communication device. With such features, the security of the electronic lock can be increased, and the management of the keys of the electronic lock can be simplified.

Furthermore, the authorization weight module 226 of the central processing unit 22 can provide a weight function, which can give a specific weight number, corresponding to an individual authorization weight or level, for each secondary key (the weight function can also modify the weight number given to each secondary key), and can give a total weight number, corresponding to a total authorization weight or level, for all the secondary keys. With such features, an original key with an authorization weight can be divided and set on multiple keys, each with a specific authorization weight, however, the total of the specific authorization weights of the multiple keys is equal to the authorization weight of the original key, thereby achieving the purpose of authorization division. For example, the user may set the total weight number to be “12”. Therefore, if the weight number for a first secondary key is set to be “12”, then the first secondary key can be used to conduct an operation that requires an authorization weight not more than 12. On another condition, if the weight number for a second secondary key is set to be “9”, whereas the weight number for a third secondary key is set to be “3”, then the second and third secondary keys can be used together to conduct an operation that requires an authorization weight not more than 12; however, the second secondary key can be used to conduct an operation that requires an authorization weight not more than 9; the third secondary key can be used to conduct an operation that requires an authorization weight not more than 3. On a further condition, if four secondary keys are each set with a weight number “3”, then the four keys can be used together to conduct an operation that requires an authorization weight not more than 12, whereas each secondary key can be used to conduct an operation that requires an authorization weight not more than 3.

Still furthermore, in addition to the password (normal password) being set above, the user is allowed to input an emergency password for emergency use. After the authentication module 222 of the central processing unit 22 confirms the emergency password, the emergency password for the portable communication device 3 can be stored in the storage module 221 as well as the normal password. Under general condition, the user may input the normal password via a normal visual interface to the portable communication device 3 to be wirelessly connected with the control mechanism 2 for operating the main lock body 1. When the user is forced to open the main lock body 1 under a threatening condition, the user can input the emergency password via an emergency visual interface to allow the control mechanism 2 to open the main lock body 1. Once the main lock body 1 is opened, the emergency unit 25 can issue an emergency message to others' mobile phones or computers, police stations, or security units, to obtain necessary help, so that the user can be well protected.

Still furthermore, the signal intensity processing unit 26 of the control mechanism 3 can detect the signal intensity from the portable communication device 3 and determine whether the portable communication device 3 is in the vicinity of the control mechanism 2 of the electronic lock. When the distance between the portable communication device 3 and the control mechanism 2 is within a predetermined range, a detection signal event can be generated. Additionally, the signal intensity processing unit 26 can be provided with a timing function, in cooperation with the signal detection capability for the portable communication device 3, to facilitate the user to operate the main lock body 1 under a difficult communication condition. For example, when the user intends to come home by taking a vehicle, the user may estimate the required time to reach home, and then employ the portable communication device 3 to communicate with the control mechanism 2 and set the delay time to open the main lock body 1 on the signal intensity processing unit 26, before taking the vehicle. Once the delay time is passed and the user has reached home (within the predetermined range of signal detection), the control mechanism 2 can drive the linking mechanism 12 to unlock the main lock body 1. This feature can facilitate the user to operate the electronic lock.

In light of the forgoing, the electronic lock of the present invention can mitigate the drawbacks of the convention locks. The present invention employs a primary portable communication device to serve as a primary key and wireless connect with a control mechanism of the electronic lock to conduct a locking or unlocking operation for a main lock body of the electronic lock. Furthermore, the primary portable communication device can communicate with the control mechanism to generate secondary keys for additional portable communication devices, each secondary key with a specific authorization level. Still furthermore, the present invention can be provided with authorization division feature. Still furthermore, the present invention can be provided with a delay time function and a signal detection capability for the portable communication devices so as to facilitate a user to operate the main lock body. Accordingly, the present invention is a useful contrivance.

Although the present invention has been described with a certain degree of particularity, it is understood that the present disclosure is made by way of example only and the combination and arrangement of parts may be resorted to without departing from the spirit and scope of the invention hereinafter claimed.

I claim:

1. An electronic lock, comprising:
a main lock body;
a control mechanism being cooperatively connected with said main lock body, said control mechanism including a connection interface connecting to said main lock body, a central processing unit connecting to said connection interface, a communication unit connecting to said central processing unit, and a power supply unit connecting to said central processing unit, and
at least one portable communication device, being capable of conducting a handshake communication with said communication unit of said control mechanism, so that said control mechanism can be controlled by said portable communication device to conduct a locking or unlocking operation for said main lock body.

2. The electronic lock of claim 1, wherein said main lock body includes a latch bolt and a linking mechanism linked to said latch bolt.

3. The electronic lock of claim 2, wherein said linking mechanism can be inserted with a key.

4. The electronic lock of claim 1, wherein said control mechanism further includes an emergency unit and a signal intensity processing unit.

5. The electronic lock of claim 1, wherein said central processing unit includes a storage module, an authentication module, an unlocking module, a signal transmission module, a copy module, and an authorization weight module.

6. The electronic lock of claim 5, wherein said unlocking module can cooperate with said portable communication device to allow said portable communication device to create a visual interface for showing a password generated from said unlocking module and a visual interface for facilitating a user to operate the lock.

7. The electronic lock of claim 1, wherein said communication unit is based on a bluetooth protocol, a short-range wireless protocol, or a wireless local area network.

8. The electronic lock of claim 1, wherein said portable communication device is a mobile telephone, a personal digital assistant, or a computer.
